(19) United States
(12) Patent Application Publication
(10) Pub. No.: US 2008/0053675 A1
(43) Pub. Date: Mar. 6, 2008

(54) Toploading ripper loop

(75) Inventors: Roy A. Klug, San Antonio, TX (US); William Manuel, San Antonio, TX (US)

Correspondence Address: William B. Nash;Jackson Walker, LLP, Suite 2400, 112 E. Pecan, San Antonio, TX, 78205, US

(73) Assignee: Holt Texas, Ltd.

(21) Appl. No.: 11/495,349

(22) Filed: Jul. 28, 2006

(51) Int. Cl. A01B 13/08

(52) U.S. Cl. 172/699

(57) ABSTRACT

A toploading ripper loop for attachment to the tool frame of a tractor has a low silhouette, elongated, v-shaped moldboard with a support arm attached at each end of the moldboard. Each support arm is formed in the shape of an upside down “J” or hook and is defined by a first elongated portion which attaches to the moldboard, a u-shaped transition portion that transitions into a second downward extending portion that terminates in a downward facing end. The downwardly facing end is disposed to engage the slot of the tool frame carried by the tractor. A support crossbeam extends between the arms, at the apex of the transition portion and above the downward facing ends, to define an enlarged choke.

### BACKGROUND OF THE INVENTION

The present invention relates to the field of land management tools for heavy duty vehicles. More particularly, the invention relates to a ripper plow for attachment to tractors and the like.

Land management tools are used for a variety of purposes that include land clearing applications, brush control and cultivation preparation. Typically such tools attached either to the existing blade of a tractor or to a rigid frame secured to the back of a tractor. While such a frame might be movable to lower and raise the attached equipment, typically such a frame is not readily removable from the tractor. Likewise, many prior art tool attachments are not readily removable from the frame. An example of such a prior art tool is the standard root plow used for brush control. A root plow is a tool designed to sheer brush below the brush bud zone, approximately 12″ to 14″ underground. Early root plows were permanently attached to the tractor at trunion mounts on a fixed frame and essentially limited the tractor to the functions of the root plow.

In response to the need for greater interchangeability among root plows and similar tools, more recent root plows have included quick release mechanisms to permit the root plow to be connected and disconnected from the tool support frame.

Typically, the tool support frame used to support the root plow is secured to the back portion of the tractor. The frame may be fixed or movable. The root plow of the prior art generally is characterized by a v-shaped moldboard with a low silhouette that easily slices through brush and tree roots. Upwardly projecting fins may be attached along the upper surface of the moldboard to move roots to the soil surface for maximum “kill” by air and sun. A straight, upwardly extending arm is secured to each end of the moldboard. Each arm terminates in an upwardly extending end. Each upwardly extending arm end is disposed to engage a slot or bracket carried by the tool support frame. Finally, a crossbeam extends between the upper ends of the two arms to provide support to the arms. The area bound by the moldboard, the crossbeams and the two arms is typically referred to as the “choke”. In operation, brush and debris uprooted by the moldboard pass through the choke.

One drawback to the prior art root plow described above is that the choke can often become clogged with brush because of the limited opening size, the dimensions of which are dictated by the spatial relationship between the arms, crossbeam and moldboard. Choke clogging is further exacerbated because the root plow is attached to the frame only a short distance from the back of the tractor. Cut brush and debris has a tendency to become entrapped in this area between the tractor and root plow, thus clogging the choke even more.

To secure a prior art tool to the tool support frame, the tool must be attached from the bottom of the frame In the case of a movable frame, typically the tractor is maneuvered until the frame is positioned above the upwardly extending arms so that the arms align with the frame slots, and thereafter, the frame is lowered onto the tool. In the case of a fixed frame, the arms of the root plow are angled up under the frame and maneuvered until the upwardly extending arms engage the slots on the frame.

The foregoing methods of securing the tool to the frame are cumbersome, particularly given that the tool is relatively heavy and difficult to maneuver. Nor do these methods lend themselves to a quick interchange of tools.

Thus, it would be desirable to provide a root plow that can more easily be attached to the existing frame typically utilized to carry the prior art root plows. Furthermore, it would be desirable to minimize choke clogging for such a root plow.

### SUMMARY OF THE INVENTION

The present invention provides a root plow, also referred to as a ripper loop, for toploading attachment to the tool frame of a tractor. The ripper loop includes an elongated, v-shaped moldboard with a support arm attached at each end of the moldboard. Each support arm is formed in the shape of an upside down “J” or hook and is defined by a first elongated portion which attaches to the moldboard, a u-shaped transition portion that transitions into a second downward extending portion that terminates in a downward facing end. The downwardly facing end is disposed to engage the slot of the tool frame carried by the tractor. A support crossbeam extends between the arms at the apex of the transition portion to define an enlarged choke.

### BRIEF DESCRIPTION OF THE DRAWINGS

FIG. 1 is top view of the ripper loop of the current invention.

FIG. 2 is a side view of the ripper loop of the current invention.

FIG. 3 is an elevation view of the ripper loop of the current invention illustrated attached to the tool frame of a tractor.

### DESCRIPTION OF THE PREFERRED EMBODIMENTS

In the detailed description of the invention, like numerals are employed to designate like parts throughout. Various items of equipment, such as fasteners, fittings, etc., may be omitted to simplify the description. However, those skilled in the art will realize that such conventional equipment can be employed as desired.

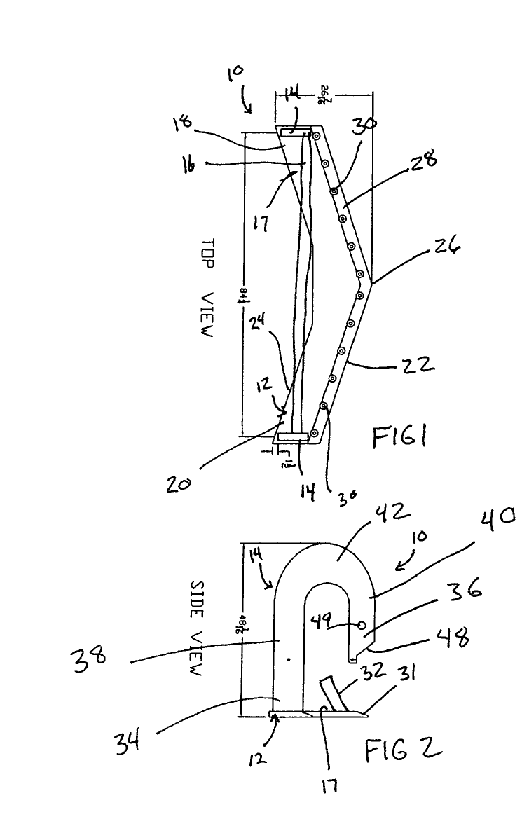

With reference to FIG. 1, there is shown a root plow or ripper loop 10. Ripper loop 10 generally has a low silhouette, substantially flat, elongated panel or moldboard 12, two upwardly extending arms 14 attached to moldboard 12 and a support crossbar 16 extending between upper portions of arms 14. Moldboard 12 is further characterized by an upper surface 17, a first end 18, a second end 20, a front edge 22 and a trailing edge 24. Preferably moldboard 12 is v-shaped thereby forming a taper or peak 26 along front edge 22. An elongated blade 28 may be attached to said front edge 22 and coextensive therewith.

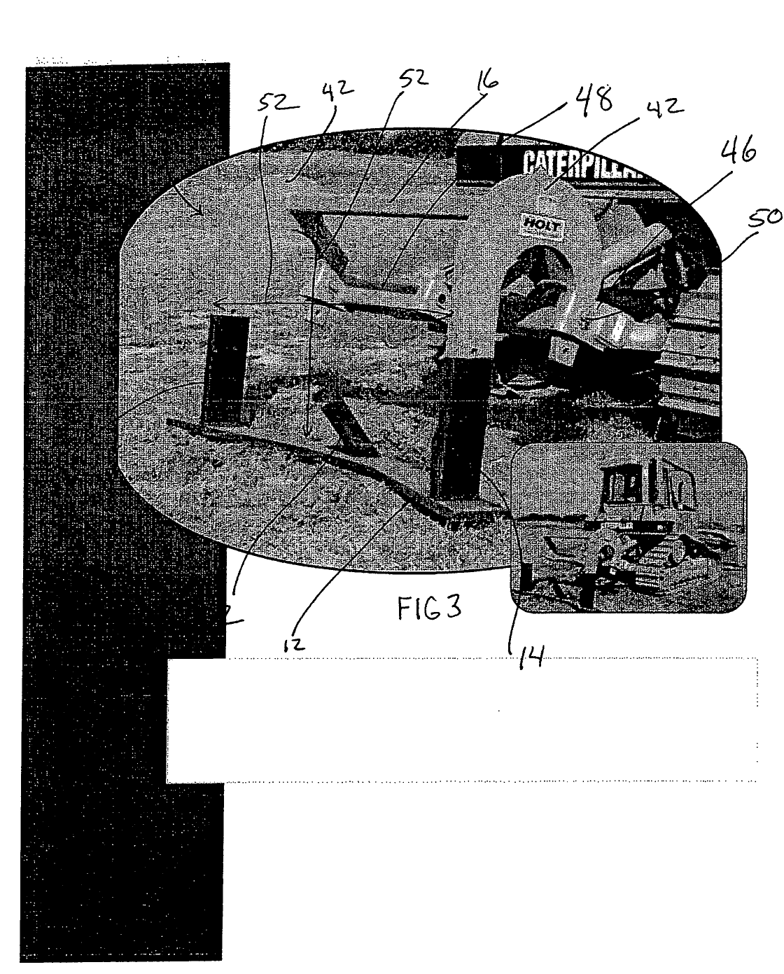

In one embodiment, elongated blade 28 is removably attached to front edge 22 with fasteners 30. In another embodiment, elongated blade 28 is an integrally formed portion of moldboard 12. In either case, elongated blade 28 may be single edged or multiple edged and sharpened, such as at 31 of FIG. 2, to further promote cutting. One or more upwardly extending fins 32 may be positioned along upper surface 17, and preferably angled toward said trailing edge 24.

Turning to FIGS. 2 and 3, an upwardly extending arm 14 is secured to the upper surface 17 of moldboard 12 at each end 18, 20. Each arm 14 is characterized by a first end 34 attached to moldboard 12 and a second end 36. Each arm 14 is shaped to have a downwardly extending, elongated first portion 38 terminating at said first end 34, a downwardly extending second portion 40 terminating at said second end 36 and a u-shaped transition portion 42 between said first and second ends 34, 36, such that arm 14 forms an overall upside down J-shape. Second end 36 may be shaped as desired for engagement with slots 46 of a tool attachment frame 48. In one embodiment, second end 36 is tapered such as at 48 to promote seating of end 36 in slot 46. Second end 46 may also include an aperture or similar engagement mechanism 49 for receipt of a securing fastener 50. While transition portion 42 has been described as unshaped and arms 14 overall have been described as being upside down J-shape, those skilled in the art will appreciate that the foregoing arms may take any shape so long as the ends 36 of arms 14 are downwardly extending so as to permit toploading as described herein.

As best seen in FIGS. 1 and 3, support crossbar 16 extends between the two arms 14, most preferably between corresponding transition portions 42 so as to be above the downward facing ends 46 of arms 14. Crossbar 16, moldboard 12 and arms 14 define a choke area 52.

The foregoing design has numerous benefits over prior art ripper-type tools. Most significantly, the downwardly extending ends 36 of arms 14 permit ripper loop 10 to be secured to frame 48 from the top of frame 48 by passing ends 36 down through slots 46. A toploading ripper loop such as this expedites attachment and eliminates many of the problems associated with bottom loading attachment of prior art tools.

Further, the arm shape of the ripper loop of the invention permits the throat area of the ripper loop to be expanded over that of prior art tools. Specifically, bottom loading tools necessitated that the support crossbar be located below the upwardly extending ends that engaged the attachment frame. By providing an arm that loops up and back down, the crossbar can be attached at the apex of the arms, above the ends of the arms that engage the frame. As such, the area of the throat is increased, decreasing the possibility of clogging therein.

While certain features and embodiments of the invention have been described in detail herein, it will be readily understood that the invention encompasses all modifications and enhancements within the scope and spirit of the following claims.

What is claimed is:

1. A ripper attachment for a tractor, said attachment comprising:
an elongated moldboard, defined by a leading edge and a trailing edge and opposite ends; and
a support arm attached to each end of the moldboard, each support arm having a first end attached to said moldboard and a second end, and shaped to have a downwardly extending, elongated first portion terminating at said first end, a downwardly extending second portion terminating at said second end and a transition portion between said first and second ends.

2. The attachment of claim 1, wherein said moldboard is a substantially flat, elongated panel.

3. The attachment of claim 1, wherein said leading edge is tapered.

4. The attachment of claim 1, further comprising an elongated blade attached to said leading edge.

5. The attachment of claim 4, wherein said elongated blade is coextensive with the leading edge.

6. The attachment of claim 4, wherein said elongated blade is removably attached to said leading edge.

7. The attachment of claim 4, wherein said elongated blade is an integrally formed portion of said moldboard.

8. The attachment of claim 1, wherein said moldboard is v-shaped between the opposite ends.

9. The attachment of claim 8, wherein said v-shaped moldboard is comprised of a first leg and a second leg and wherein said first and second legs form a forward projecting apex along said leading edge.

10. The attachment of claim 1, wherein said transition portion is u-shaped.

11. The attachment of claim 1, wherein each support arm is upside down j-shaped.

12. The attachment of claim 1, further comprising a crossbar extending between said arms.

13. The attachment of claim 12, wherein said crossbar attaches to said arms between corresponding transition portions.

14. The attachment of claim 12, wherein said crossbar attaches to said arms above said second end of said arms.

15. A ripper attachment for a tractor, said attachment comprising:
an elongated, v-shaped moldboard, defined by a leading edge and a trailing edge and opposite ends;
a support arm attached to each end of the moldboard, each support arm having a first end attached to said moldboard and a second free end, and shaped to have a downwardly extending, elongated first portion terminating at said first end, a downwardly extending second portion terminating at said second free end; and
a crossbar extending between said arms, wherein said crossbar attaches to said arms above said second end of said arms.

16. A ripper attachment for a tractor, said attachment comprising:
an elongated moldboard, defined by a leading edge and a trailing edge and opposite ends;
an elongated, tapered blade attached to said leading edge of said moldboard;
a support arm attached to each end of the moldboard, each support arm having a first end attached to said moldboard and a second end, and shaped to have a downwardly extending, elongated first portion terminating at said first end, a downwardly extending second portion terminating at said second end and a u-shaped transition portion between said first and second ends, wherein each u-shaped transition portion includes an apex;
a crossbar extending between said arms, wherein said crossbar attaches to said arms at the apex of said u-shaped transition portion.
